(19) United States
(12) Patent Application Publication
(10) Pub. No.: US 2026/0065061 A1
(43) Pub. Date: Mar. 5, 2026

(54) METHOD AND APPARATUS FOR GENERATING PREDICTION MODEL AND PREDICTION SYSTEM USING THE SAME

(71) Applicant: Samsung Electronics Co., Ltd., Suwon-si (KR)

(72) Inventors: Hyeong Jun JEONG, Suwon-si (KR); Minkyu KIM, Suwon-si (KR); Sung Yoon RYU, Suwon-si (KR); Young-Seok KIM, Suwon-si (KR); Taejin KIM, Suwon-si (KR); Gwanghun JUNG, Suwon-si (KR)

(21) Appl. No.: 19/192,597

(22) Filed: Apr. 29, 2025

(30) Foreign Application Priority Data
Aug. 29, 2024 (KR) 10-2024-0116951

(51) Int. Cl. G06N 3/084

(52) U.S. Cl. CPC G06N 3/084

(57) ABSTRACT

A method and an apparatus of generating a trained prediction model includes obtaining first spectrum data from a target structure of a semiconductor substrate, generating a first grid map for the semiconductor substrate by reducing dimension of the first spectrum data, generating a second grid map for the semiconductor substrate from the first spectrum data by using a prediction model for parameters of interest of the target structure, and training the prediction model based on the first grid map and the second grid map.

### CROSS-REFERENCE TO RELATED APPLICATIONS

This application claims the benefit of Korean Patent Application No. 10-2024-0116951, filed on Aug. 29, 2024, in the Korean Intellectual Property Office, the disclosure of which is herein incorporated by reference in its entirety.

### BACKGROUND

### 1. Field of the Invention

Example embodiments relate to a method and an apparatus for generating a prediction model and a prediction system using the same.

### 2. Description of the Related Art

In a semiconductor process, measurement is a very important technology. The measurement includes accurately measuring the size, thickness, composition, and other characteristics of the structure or shape generated in each process, and thus plays a role in managing quality and reducing process variation. However, as semiconductor devices are extremely small (e.g., on the nanometer (nm) scale) and the structure of semiconductor devices is very complex and includes multiple layers, the challenges associated with accurate measurement technologies are exceptionally high.

With regard to measurement methods for semiconductor devices, there is non-destructive testing to test wafers in which the wafers are not damaged. For example, the measurement on semiconductor devices may be performed without damaging wafers through optical inspections that uses light to inspect surface defects or structures of an object.

### SUMMARY

An aspect provides a method and an apparatus for generating a prediction model by which the prediction accuracy of a 3D microstructure of a sample is improved using gradients for a specific component of spectrum data of the same as learning data, and a prediction system using the method and the apparatus.

However, the goals to be achieved by example embodiments of the present disclosure are not limited to the technical aspects described above, and other goals may be inferred from the following example embodiments.

According to an aspect of the present disclosure, there is provided a method of generating a trained prediction model, the method including obtaining first spectrum data from a target structure of a semiconductor substrate, generating a first grid map for the semiconductor substrate by reducing dimension of the first spectrum data, generating a second grid map for the semiconductor substrate from the first spectrum data by using a prediction model for parameters of interest of the target structure, and training the prediction model based on the first grid map and the second grid map.

According to an aspect of the present disclosure, there is provided a non-transitory computer-readable recording medium having a program for executing the method of generating the trained prediction model on a computer.

According to an aspect of the present disclosure, there is provided a prediction system including an inspection apparatus configured to irradiate incident polarized light onto a semiconductor substrate, obtain at least one polarization of transmission polarization and reflection polarization of the incident polarized light reflected from the semiconductor substrate, and output spectrum data for a target structure of the semiconductor substrate based on the at least one polarization, and a prediction apparatus configured to output a prediction value for a parameter of interest of the target structure based on the spectrum data using a prediction model, wherein the prediction model is trained based on a first grid map that is generated by reducing dimension of first spectrum data and a second grid map that is generated from the first spectrum data using the prediction model, and the first spectrum data is obtained from a plurality of measurement points of the semiconductor substrate using the inspection apparatus.

According to an aspect of the present disclosure, there is provided an apparatus of generating a trained prediction model, the apparatus including a memory configured to store at least one program and at least one processor configured to execute the at least one program, wherein the at least one processor is configured to obtain first spectrum data for a target structure of a semiconductor substrate, generate a first grid map for the semiconductor substrate by reducing dimension of the first spectrum data, generate a second grid map for the semiconductor substrate from the first spectrum data by using a prediction model for parameters of interest of the target structure, and train the prediction model based on the first grid map and the second grid map.

Additional aspects of the present disclosure will be set forth in part in the description which follows and, in part, will be apparent from the description, or may be learned by practice of the disclosure.

According to example embodiments, it is possible to provide a prediction model with high consistency even in situations where reference data on samples is lacking in technical fields such as semiconductors.

According to example embodiments, it is possible to use spectrum data by which sufficient amount of data is quickly obtained without destroying samples, as training data for a prediction model.

Effects of the present disclosure are not limited to those described above, and other effects may be made apparent to those skilled in the art from the following description.

### BRIEF DESCRIPTION OF THE FIGURES

These and/or other aspects, features, and advantages of the invention will become apparent and more readily appreciated from the following description of example embodiments, taken in conjunction with the accompanying drawings of which:

FIG. 1 is a diagram illustrating an environment for generating a prediction model according to an example embodiment;

FIG. 2 is a flowchart of a method of generating a prediction model according to an example embodiment;

FIG. 3 is a drawing for explaining a target structure of a semiconductor substrate according to an example embodiment;

FIG. 4A and FIG. 4B are drawings illustrating grid maps according to an example embodiment;

FIG. 5 is a diagram illustrating a method of generating a first grid map and a second grid map according to an example embodiment;

FIG. 6 is a drawing for explaining spectrum data and grid maps of test substrates according to an example embodiment;

FIG. 7 is a drawing for explaining principal component analysis according to an example embodiment;

FIG. 8 is a drawing for explaining a method of calculating a principal component distance according to an example embodiment;

FIG. 9 is a diagram illustrating a method of training a prediction model according to an example embodiment;

FIG. 10 is a diagram illustrating a method of obtaining a final prediction value according to an example embodiment;

FIG. 11 is flowcharts of a method of generating a prediction model according to an example embodiment;

FIG. 12 is a block diagram of a prediction system according to an example embodiment;

FIG. 13 is a drawing illustrating an inspection apparatus according to an example embodiment; and

FIG. 14 is a block diagram of an apparatus for generating a prediction model according to an example embodiment.

### DETAILED DESCRIPTION

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising or including” a component, it does not exclude another component but may include another component unless otherwise stated. Furthermore, terms such as “ . . . unit,” “ . . . group,” and “ . . . module” described in the specification mean a unit that processes at least one function or operation, which may be implemented as hardware, software, or a combination thereof.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments will be described in detail with reference to the drawings.

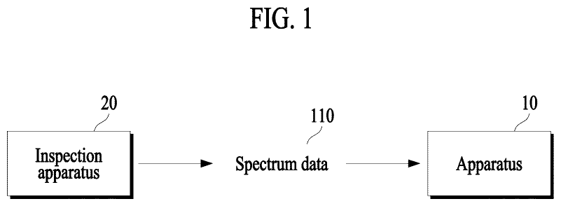

FIG. 1 is a diagram illustrating an environment for generating a prediction model according to an example embodiment.

Referring to FIG. 1, an environment for generating a prediction model according to example embodiments may include an apparatus (hereinafter referred to as “apparatus”) 10 for generating a prediction model and an inspection apparatus 20.

In an example embodiment, the inspection apparatus 20 may generate spectrum data 110 for the target structure of the sample. In an example embodiment, an ellipsometer and any reflectometry to measure the polarization state of light to analyze the optical properties of the sample may be included. The sample may include a semiconductor substrate such as a silicon substrate or a glass substrate.

The spectrum data 110 (i.e., the polarization spectrum data) is data that represents the change in polarization state according to the wavelength of light. For example, the spectrum data 110 may include information on changes in polarization caused by polarization reflected or transmitted from a sample by the inspection apparatus 20. For example, when light interacts with the sample's surface or sub-layers of the sample, its polarization changes due to reflection, refraction, scattering, and absorption. The spectrum data 110 may measure how the polarization the light changes as a function of wavelength, and may encode film thickness, refractive index, layer uniformity, or surface roughness. Accordingly, when the spectrum data 110 is analyzed, the physical and chemical properties of the sample's structure, such as thin films, surfaces, and layer structures, may be identified.

In an example embodiment, the spectrum data 110 may include at least one of an X-ray spectrum, an ultraviolet spectrum, a visible light spectrum, a near infrared spectrum, a mid-infrared spectrum, a far infrared spectrum, and a terahertz (THz) spectrum. In an embodiment, the spectrum data may be expressed as N, C, S, alpha, beta, psi, or delta which indicate the state of elliptical polarization. Depending on the degree of polarization, it may be expressed as individual components of the Jones Matrix or individual components of the Mueller matrix. The elliptical polarization is a phenomenon that occurs when there is a reflectivity and phase difference between the electric field of s-polarization or a transverse electric (TE) mode and the electric field of p-polarization or a transverse magnetic (TM) mode, and the elliptical polarization may be expressed by the Jones vector, Stokes vector and Poincaré sphere.

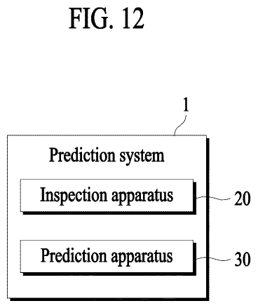

The inspection apparatus 20 may include a detector (not illustrated) that acquires polarized light reflected or transmitted by the sample, and a post-processing apparatus (not illustrated) that analyzes the acquired polarization to generate spectrum data. The spectrum data 110 generated by the inspection apparatus 20 may be stored in the internal memory (not illustrated) of the inspection apparatus 20, and may also be stored in a separate memory or server (not illustrated) outside the inspection apparatus 20. The structure and operating principle of the inspection apparatus 20 will be described in detail later through FIG. 12.

In an example embodiment, the inspection apparatus 20 may be a vertical optical system in which light is incident perpendicularly to the sample surface or may be an inclined optical system in which light is incident at a specific angle (between 0 and 90 degrees) with respect to the specimen surface. The spectrum data 110 may include all reflected or transmitted light having a wavelength range measured from the inspection apparatus 20.

In an example embodiment, the apparatus 10 may obtain the spectrum data 110 generated by the inspection apparatus 20. In an embodiment, the apparatus 10 may train a prediction model using the spectrum data 110. For example, the prediction model may be an artificial intelligence model that predicts the parameters of interest of the target structure of the sample.

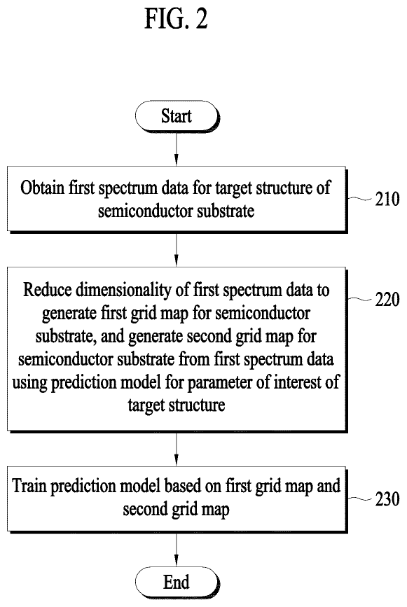

FIG. 2 is a flowchart of a method of generating a prediction model according to an example embodiment.

Referring to FIG. 2, in operation 210, the apparatus 10 may obtain first spectrum data for the target structure of a semiconductor substrate.

In an example embodiment, the first spectrum data may indicate spectrum data for multiple measurement points of a semiconductor substrate. For example, the first spectrum data may be spectrum data on polarization acquired for all multiple measurement points of the semiconductor substrate. For example, the apparatus 10 may obtain spectrum data from the multiple measurement points of the semiconductor substrate. Operation 220 and operation 230 will be described later.

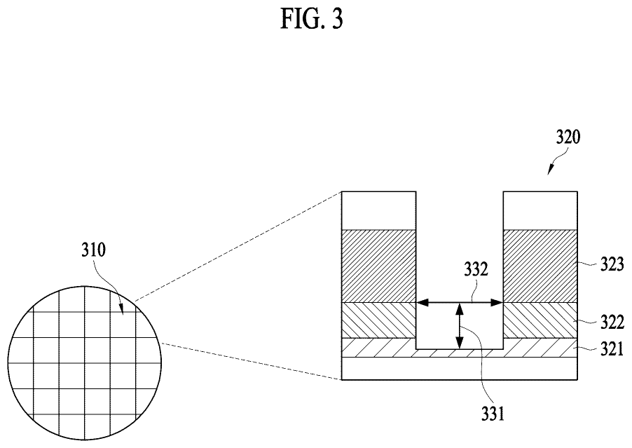

FIG. 3 is a drawing for explaining a target structure of a semiconductor substrate according to an example embodiment.

FIG. 3 illustrates a target structure 320 corresponding to a measurement point 310 of a semiconductor substrate.

In an example embodiment, the semiconductor substrate may include a plurality of measurement points 310. The measurement point refers to an area on the semiconductor substrate where measurement is to be performed, or an area on the semiconductor substrate from which spectrum data is desired.

In an example embodiment, the semiconductor substrate may be divided into a virtual grid shape, and a predetermined point corresponding to each square of the grid, such as the center or corner of each square of the grid, may be determined as the measurement point 310. Each square of the grid may correspond to a die of the semiconductor substrate. In another example embodiment, points in a specific area, such as the edge or center of a semiconductor substrate, may be determined as the measurement points 310. In another example embodiment, at least some of the multiple measurement sites (for example, OS sites) on the semiconductor substrate may be determined as the measurement points 310.

The target structure 320 is a structure that contains the parameter of interest to be measured. For example, the target structure 320 may be a two-dimensional or three-dimensional structure. In an example embodiment, when the target structure 320 is in a hole spacer etch back structure (hereinafter referred to as the “etch back structure”) in the semiconductor process, the parameter of interest may be the recess height (hereinafter referred to as “RCSHT”) 331 from the lower boundary surface of a third material (for example, polycrystalline silicon) 323. For example, referring to FIG. 3, in a structure having layers each composed of a first material 321, a second material 322 and the third material 323, the RCSHT 331 may indicate RCSHT from the lower boundary of the layer composed of the third material 323 after the etching process. The first material 321, the second material 322 and the third material 323 are only a mere example embodiment to express the layer structure to explain the RCSHT 331. In an example embodiment, the first material 321, the second material 322 and the third material 323 may all be different, or the first material 321 and the third material 323 may be identical and only the second material 322 may be different. However, the present disclosure is not limited thereto.

In an embodiment, when the target structure 320 is an etch back structure, the parameter of interest is not limited to the RCSHT 331. The parameter of interest may be one or more of various parameters that may be measured in the target structure 320, such as the distance between the bottom surfaces of the third material 323 (a bottom critical dimension, BCD 332) and the distance between the top surfaces of the third material 323 (top critical dimension, TCD) (not illustrated). The present disclosure is not limited thereto. For example, the parameter of interest refers to a value to be measured in the target structure 320.

In the case where the difficulty of the process for the target structure 320 in the above example embodiments is high and there is a high probability of causing a problem phenomenon or generating a defect, fine control and high-precision measurement of parameters of interest such as the RCSHT 331 are desirable. The implementation of the optical critical dimension (OCD) model may be difficult due to very low sensitivity of the parameter of interest or structural problems in the target structure 320. The OCD model is a computational framework used in OCD metrology to measure and analyze tiny features on a semiconductor substrate. For example, the OCD may be a simulation and fitting tool that uses optical data to determine critical physical properties of a structure formed on a semiconductor substrate. Therefore, in the present disclosure, example embodiments relate to a method of generating a prediction model with high consistency by training a prediction model for the parameters of interest using analysis results of spectrum data acquired in a non-destructive manner as learning data (i.e., learning references).

Referring to FIG. 2, in operation 220, the apparatus 10 may reduce the dimensionality of the first spectrum data to generate a first grid map for the semiconductor substrate, and generate a second grid map for the semiconductor substrate from the first spectrum data using the prediction model for parameters of interest of the target structure.

As described above, the first spectrum data may indicate spectrum data for multiple measurement points of a semiconductor substrate. In an embodiment, the first grid map may be generated based on the dimensionality reduction of the first spectrum data.

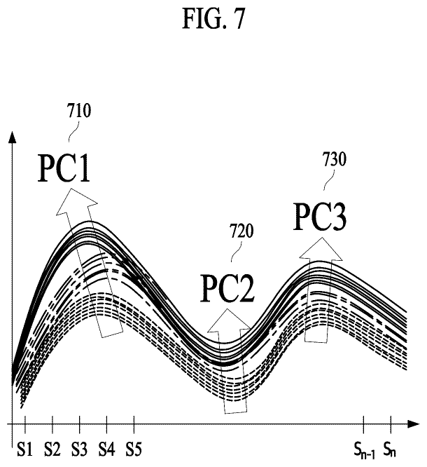

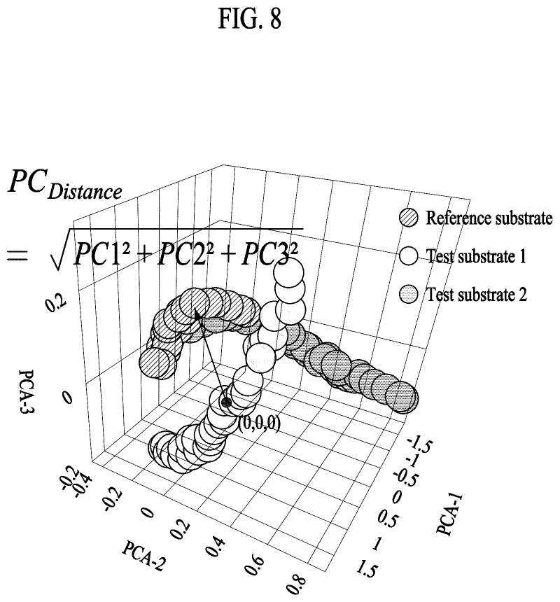

In an example embodiment, as a result of dimension reduction for the first spectrum data, the apparatus 10 may generate a first grid map by mapping a specific pattern of gradients for multiple measurement points onto a grid map for a semiconductor substrate. The gradient is the rate of change in physical properties such as thickness and critical dimensions. In an embodiment, the grid map may include location information of each square (i.e., each cell) of the grid which represents a corresponding measurement point. In an example embodiment, the dimension reduction may be principal component analysis. In another example embodiment, the dimension reduction may include at least one of clustering techniques including k-means clustering, density-based spatial clustering of applications with noise (DBSCAN) and hierarchical clustering and t-distributed stochastic neighbor embedding (t-SNE). The method by which the apparatus 10 performs principal component analysis to generate the first grid map will be described later with reference to FIG. 7 and FIG. 8.

In an example embodiment, the apparatus 10 may generate a second grid map by inputting the first spectrum data into the prediction model and mapping the gradient of the prediction value output by the prediction model to the grid map for the semiconductor substrate. Hereinafter, described are example embodiments in which a prediction model is generated.

In an example embodiment, the prediction model may be generated based on second spectrum data for a target structure corresponding to at least one of a plurality of measurement points of a semiconductor substrate, and experimental values for parameters of interest corresponding to the second spectrum data.

In example embodiment of the present disclosure, the prediction model being generated may indicate that initial parameters of the prediction model are set, and this may be different from generating the final prediction model by training the prediction model in the present disclosure.

Unlike the first spectrum data, which refers to spectrum data for multiple measurement points on a semiconductor substrate, the second spectrum data is spectrum data for at least one of multiple measurement points of the semiconductor substrate. In an embodiment, the second spectrum data may be identical to the first spectrum data, or may contain only a portion of the first spectrum data. Therefore, an experimental value for parameter of interest corresponding to the second spectrum data may indicate an experimental value for the parameter of interest at a measurement point (hereinafter referred to as a “destructive inspection point”) corresponding to the data included in the second spectrum data among multiple measurement points. In an embodiment, after spectrum data for the target structure of the semiconductor substrate is acquired, experimental values are acquired through destructive testing at destructive testing points, and here the spectrum data acquired at the destructive testing point may be defined as second spectrum data. The destructive testing may be performed by using transmission electron microscope (TEM) or scanning electron microscope (SEM).

For example, the spectrum data of destructive testing points may be matched with experimental values corresponding to each point as labels, and thus the prediction model may be generated based on second spectrum data and experimental values. Alternatively, in the prediction model, initial parameters may be set based on second spectrum data and experimental values. In an example embodiment, the prediction model may be generated by supervised learning by using the second spectrum data as input data and the experimental value as the correct (label) data.

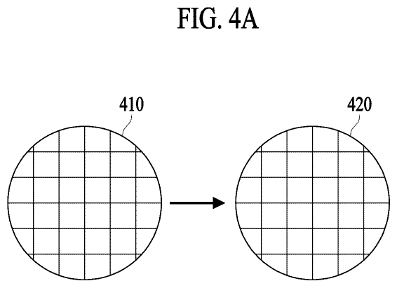

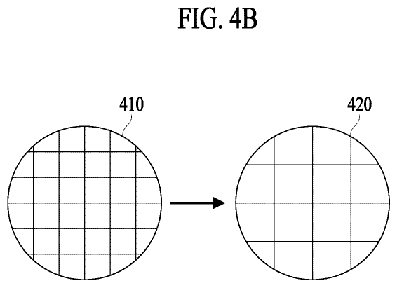

FIG. 4A and FIG. 4B are drawings illustrating grid maps according to an example embodiment.

A grid map 420 may be generated to correspond to a semiconductor substrate 410. For example, the grid map 420 may be an expression in which information about the characteristics of the semiconductor substrate 410 is mapped to each square of the grid (i.e., each cell of the grid). In an embodiment, the grid map 420 may include location information of each cell of the grid.

Referring to FIG. 4A, in an example embodiment, with regard to the grid map 420 for the semiconductor substrate 410, the square in the grid may be formed to correspond to each of the plurality of measurement points of the semiconductor substrate 410. For example, the measurement points of the semiconductor substrate 410 and the squares of the grid map 420 (i.e., the cells of the grid map 420) may correspond one-to-one.

In an embodiments, the multiple measurement points of the semiconductor substrate 410 correspond to dies of the semiconductor substrate 410, which will be sliced into individual dies. Each square of the grid map 420 may also be formed to correspond to a corresponding die of the semiconductor substrate 410.

In an example embodiment, a first grid map for the semiconductor substrate 410 may be generated as a result of dimension reduction of the first spectrum data, and a specific pattern of gradient for each of the multiple measurement points of the semiconductor substrate 410 may be mapped to each square of the grid map 420. Similarly, in an example embodiment, a second grid map for the semiconductor substrate 410 may be generated by the gradient of the prediction value of each of the multiple measurement points output by the prediction model for the first spectrum data being mapped to each square of the grid map 420.

The grid map 420 may be used as training data for the prediction model, and in order to improve the performance of the prediction model trained using the grid map 420, it is desirable to increase the resolution of the grid map 420. Therefore, when the apparatus increases the number of multiple measurement points, the resolution of the grid map 420 increases, and accordingly, the quality of the grid map 420 as training data may be improved.

Referring to FIG. 4B, in an example embodiment, the grid map 420 for the semiconductor substrate 410 may be formed to have a smaller number of squares than the number of measurement points of the semiconductor substrate 410. For example, the measurement points of the semiconductor substrate 410 and the square of the grid map 420 may correspond in a many-to-one relationship.

In an embodiment, the grid map 420 may be used as training data for the prediction model, and in order to reduce the amount of computation required to train a prediction model using the grid map 420, it is desirable to lower the resolution of the grid map 420. Therefore, by reducing the number of squares in the grid map 420, the learning data is made lighter, and thus the workload of the processor may be reduced. Alternatively, when the first spectrum data is spectrum data for polarization acquired for some of the multiple measurement points of the semiconductor substrate 410, the square of the grid map 420 cannot be formed to correspond to all of the multiple measurement points. Therefore, by reducing the number of squares in the grid map 420, training data may be generated to train a prediction model even when the first spectrum data information is insufficient.

In an embodiment, each square of the grid map 420 may include characteristics for at least two of the multiple measurement points. For example, each square of the grid map 420 may have features mapped to 2*2 points (4 points in 2 rows and 2 columns) among multiple measurement points. In an example embodiment, in each square of the grid map 420, the average of the features for 2*2 points may be mapped and expressed. However, 2*2 points is a mere example embodiment, and an example embodiment of a many-to-one correspondence between the measurement points of the semiconductor substrate 410 and each square of the grid map 420 is not limited thereto. As described above with reference to FIG. 4A, the feature mapped to each square of the grid map 420 may be the result of dimension reduction of the first spectrum data in the case of the first grid map, or a gradient of a specific pattern. In the case of the second grid map, the feature mapped to each square of the grid map 420 may be the gradient of the prediction value.

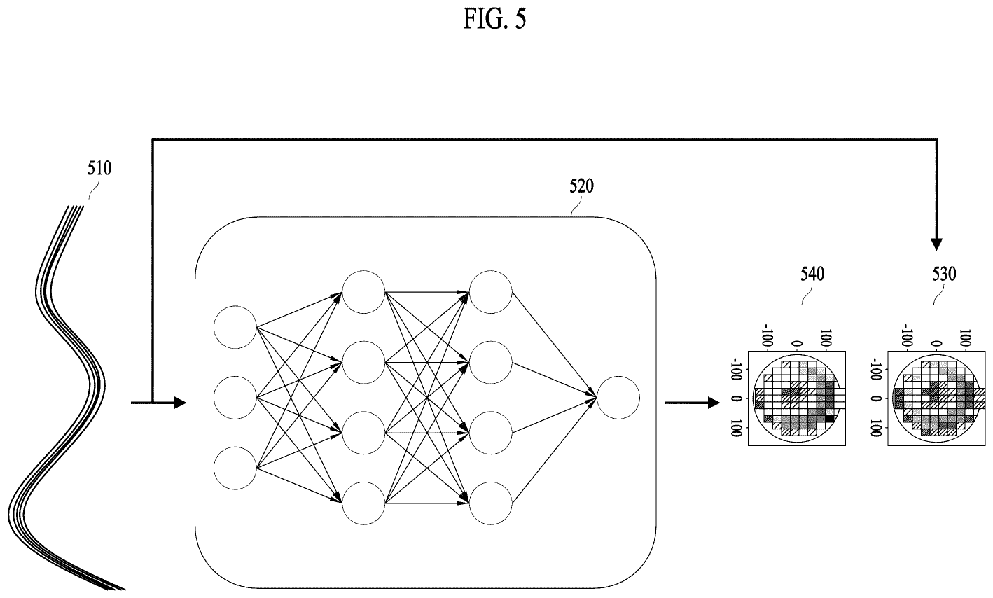

FIG. 5 is a diagram illustrating a method of generating a first grid map and a second grid map according to an example embodiment.

In an example embodiment, the apparatus 10 may generate a first grid map 530 based on first spectrum data 510. The apparatus 10 may reduce the dimension of the first spectrum data 510 to generate the first grid map 530. For example, the apparatus 10 may perform principal component analysis on the first spectrum data 510 to extract one or more principal components. After then, the apparatus 10 may calculate principal component distances corresponding to each of a plurality of measurement points based on one or more principal components. The apparatus 10 may generate the first grid map 530 based on the principal component distance. For example, the apparatus 10 may generate the first grid map 530 by mapping the gradient of the principal component distance to a grid map for a semiconductor substrate. The method by which the apparatus 10 performs the principal component analysis will be described later with reference to FIG. 7 and FIG. 8.

In an example embodiment, the apparatus 10 may generate a second grid map 540 based on the first spectrum data 510. For example, the apparatus 10 may obtain the prediction value of the parameter of interest corresponding to the first spectrum data 510 using a prediction model 520. After then, the apparatus 10 may generate the second grid map 540 based on prediction values corresponding to each of multiple measurement points. For example, the apparatus 10 may generate the second grid map 540 by mapping the gradient of the prediction value to a grid map for the semiconductor substrate.

The prediction model 520 may be an arbitrary model trained by samples. For example, the prediction model 520 may be based on an artificial neural network, a decision tree, a support vector machine, a regression analysis, a Bayesian network, and a genetic algorithm. Hereinafter, the prediction model 520 will be described mainly with reference to the artificial neural network (ANN). However, exemplary embodiments of the inventive concept are not limited thereto.

An ANN is a hardware or a software component that includes a number of connected nodes (i.e., artificial neurons), which loosely corresponds to the neurons in a human brain. Each connection, or edge, transmits a signal from one node to another (like the physical synapses in a brain). When a node receives a signal, it processes the signal and then transmit the processed signal to other connected nodes. In some cases, the signals between nodes comprise real numbers, and the output of each node is computed by a function of the sum of its inputs. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

As a non-limiting example, the artificial neural network may be a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, or a classification network.

An S-DNN refers to a neural network aggregated with multiple basic learning modules, one after another, to synthesize a deep neural network (DNN). Unlike a some DNNs trained end-to-end using backpropagation, S-DNN layers may be trained independently without backpropagation.

An S-SDNN extends a dynamic neural network (DNN) to include a robust state-space formulation. In some cases, a training algorithm exploiting an adjoint sensitivity computation is utilized to enable an SSDNN to efficiently learn from transient input and output data without relying on the circuit internal details.

A DBN is a generative graphical model (or a class of deep neural network), composed of multiple layers of latent variables with connections between the layers but not between units within each layer. When initially trained on a set of examples without supervision, a DBN can learn to probabilistically reconstruct its inputs. The layers can act as feature detectors. After initial training, a DBN can be further trained with supervision to perform classification.

A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

In some cases, a standard CNN may not be suitable when the length of the output layer is variable, i.e., when the number of the objects of interest is not fixed. Selecting a large number of regions to analyze using conventional CNN techniques may result in computational inefficiencies. Thus, in the R-CNN approach, a finite number of proposed regions are selected and analyzed.

A deconvolution layer refers to a neural network layer that performs a convolution while attempting to decorrelate channel-wise and spatial correlation. For example, in some cases a deconvolution layer may include white space, or padding to input data.

An RNN is a class of ANN in which connections between nodes form a directed graph along an ordered (i.e., a temporal) sequence. This enables an RNN to model temporally dynamic behavior such as predicting what element should come next in a sequence. Thus, an RNN is suitable for tasks that involve ordered sequences such as text recognition (where words are ordered in a sentence). The term RNN may include finite impulse recurrent networks (characterized by nodes forming a directed acyclic graph), and infinite impulse recurrent networks (characterized by nodes forming a directed cyclic graph).

An LSTM is a form of RNN that includes feedback connections. In one example, and LSTM includes a cell, an input gate, an output gate and a forget gate. The cell stores values for a certain amount of time, and the gates dictate the flow of information into and out of the cell. LSTM networks may be used for making predictions based on series data where there can be gaps of unknown size between related information in the series. LSTMs can help mitigate the vanishing gradient (and exploding gradient) problems when training an RNN.

An RBM is a generative stochastic artificial neural network that can learn a probability distribution over its set of inputs. Specifically, an RBM is a Boltzmann machine with the restriction that neurons must form a bipartite graph (i.e., a pair of nodes from each of the two groups of units that have a symmetric connection between them); and there are no connections between nodes within a group. By contrast, “unrestricted” Boltzmann machines may have connections between hidden units. The restriction in an RBM allows for more efficient training algorithms than are available for the general class of Boltzmann machines such as a gradient-based contrastive divergence algorithm.

In an example embodiment, a value corresponding to each square of the first grid map 530 and the second grid map 540 may be a specific value, a one-dimensional vector, or a two-dimensional matrix. For example, the principal component distance or the prediction value described above may have a specific value in a one-dimensional vector or a two-dimensional (2D) matrix. For example, when the dimension reduction result for the first spectrum data 510 is 2D or higher dimension, a value corresponding to each square of the first grid map 530 may be represented by a one-dimensional vector or a 2D matrix.

In an example embodiment, in the first grid map 530 and the second grid map 540, an area of each square of the grid may be expressed in color based on a value corresponding to each square. For example, the area of each square of the grid may be expressed in color based on the size of the value corresponding to each square. The larger the size of the value corresponding to each square of the grid, the darker the color of the area of each square may be. Alternatively, each area of each square of the grid may be represented by a predetermined color corresponding to the size of the value. In another example embodiment, an area of each square of the grid may be expressed in shade based on the size of the value corresponding to each square. The larger the size of the value corresponding to each square of the grid, the darker the shade of each square may be. However, the above descriptions are mere example embodiments. An example embodiment where an area of each square of the grid is represented by a color based on the value corresponding to each square in the first grid map 530 and the second grid map 540 is not limited thereto.

In an example embodiment, the first spectrum data 510, the first grid map 530 and the second grid map 540 may be generated corresponding to each of a reference substrate and one or more test substrates.

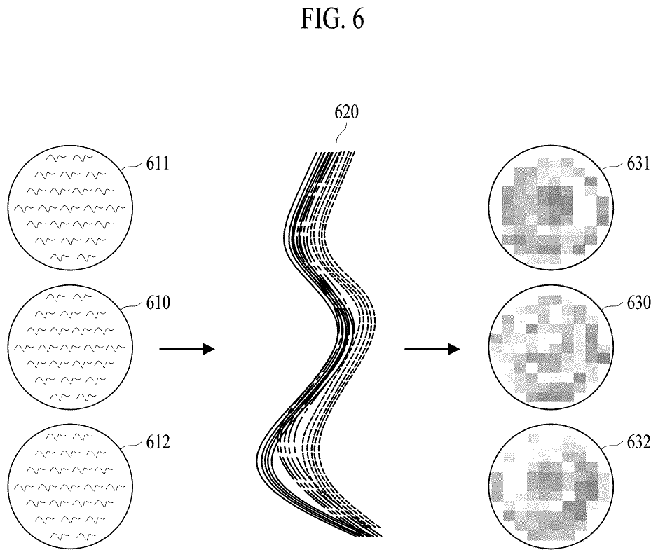

FIG. 6 is a drawing for explaining spectrum data and grid maps of test substrates according to an example embodiment.

FIG. 6 illustrates a reference substrate 610, and one or more test substrates (test substrates 611 and 612).

At least one process condition of the reference substrate 610 may be changed and applied to the test substrates 611 and 612. In an example embodiment, the at least one of the process conditions may be a process condition regarding a parameter of interest. In an embodiment, the process conditions regarding the parameter of interest may be set based on a design of experiment (DOE) method.

For example, in the etch back structure described above, at least one of the process conditions may be a condition relating to an etching process. For example, when defining the process conditions of the reference substrate 610 as target RCSHT, process conditions that are smaller or larger than the target RCSHT by a given value are applied to the test substrates 611 and 612. However, the RCSHT is a mere example embodiment of the process conditions, and etching process time corresponding to the RCSHT or the amount of material used in the process may be at least one process condition that is applied to the test substrates 611 and 612 as modified. However, the present disclosure is not limited thereto.

In another example embodiment, at least one of the process conditions may be a condition regarding a chamber. The semiconductor process is a micro process, and structure and performance results may vary depending on a wide variety of factors. There are physical, environmental and operational differences between the chambers where the process takes place such as differences in design, differences in design conditions, differences in the degree of contamination, differences in durability and differences in process control (for example, the method or criteria for detecting the end point of a process). Therefore, even if semiconductor substrates undergo processing under the same process conditions, if the process is performed in different chambers, the resulting structures may be different. In an embodiment, the test substrates 611 and 612 may be the result of conditions for the reference substrate 610 and the chamber being changed and applied. For example, the test substrates 611 and 612 may be the result of being processed in a chamber different from a chamber of the reference substrate 610.

In an example embodiment, first spectrum data 620 may be generated for each of the reference substrate 610 and one or more test substrates (the test substrates 611 and 612). For example, the apparatus 10 may obtain first spectrum data (hereinafter referred to as “1-1 spectrum data”) for a target structure of the reference substrate 610, obtain first spectrum data (hereinafter referred to as “1-2 spectrum data”) for the target structure of test substrate 611, and may also obtain first spectrum data (hereinafter referred to as “1-3 spectrum data”) for the target structure of another test substrate 612. The data set of 1-1 to 1-3 spectrum data may be called first spectrum data 620.

In an example embodiment, grid maps 630, 631 and 632 may be generated for each of the reference substrate 610 and one or more test substrates (the test substrates 611 and 612). For example, the apparatus 10 may generate a grid map 630 of the reference substrate 610 based on the 1-1 spectrum data, generate a grid map 631 of the test substrate 611 based on the 1-2 spectrum data, and also generate a grid map 632 of the test substrate 612 based on the 1-3 spectrum data. In the example embodiment, the grid maps 630, 631 and 632 include a first grid map and a second grid map, and an example embodiment of generating a first grid map and a second grid map based on the first spectrum data 620 is identical to what is described above.

The 1-1 spectrum data and the grid map 630 of the reference substrate 610 may be configured as one data group as training data for the prediction model, and also, the 1-2 spectrum data and the grid map 631 of the test substrate 611 may be configured as one data group, and the 1-3 spectrum data and the grid map 632 of the test substrate 612 may be configured as one data group as training data for the prediction model. For example, training the prediction model based on the first spectrum data 620, the first grid map, and the second grid map indicates training a prediction model based on a first data set containing the 1-1 spectrum data, the grid maps 630 (the first grid map and second grid map), a second data set containing the 1-2 spectrum data, the first grid map 631 and the second grid map, and a third data set including the 1-3 spectrum data, the first grid map and the second grid map 632.

FIG. 7 is a drawing for explaining principal component analysis according to an example embodiment.

In an example embodiment, the apparatus 10 may perform principal component analysis on the first spectrum data to extract one or more principal components (principal components 710, 720 and 730).

The principal component analysis is an analysis method that reduces high-dimensional data to low-dimensional data to find important patterns or structures. For example, by performing the principal component analysis on the first spectrum data, the apparatus 10 may reduce the dimensionality of the first spectrum data into a smaller set of dimensions (i.e., principal components) while preserving the variance of the first spectrum data. In the principal component analysis, new low-dimensional axes, which are the principal components 710, 720 and 730, may be extracted from the first spectrum data. The apparatus 10 may further project the first spectrum data into a space with the principal components 710, 720 and 730 as axes. The principal components 710, 720 and 730 are the factors that explain the variance of the first spectrum data. For example, the principal component 710, which shows the largest variance, may be defined as PC1, the principal component 720, which represents the second largest variance smaller than the largest variance, may be defined as PC2, and the principal component 730, which represents the third largest variance smaller than the second largest variance, may be defined as PC3, but the criteria for extracting the principal components 710, 720 and 730 are not limited thereto.

In an example embodiment, the apparatus 10 may obtain the variance and covariance between each feature by calculating the covariance matrix of the first spectrum data, and produce eigenvalues and eigenvectors of the covariance matrix. The eigenvector represents the direction in which the variance of the first spectrum data is greatest, and thus the apparatus 10 may determine at least one of the eigenvectors as the principal components 710, 720 and 730 of the first spectrum data. Eigen vectors with large eigen values explain most of the variation in the first spectrum data and thus the apparatus 10 may determine the upper predetermined number of eigen vectors with large eigen values as the principal components 710, 720 and 730 of the first spectrum data.

When the first spectrum data is for a reference substrate and one or more test substrates, the variation of the first spectrum data according to the process conditions for the parameter of interest is more pronounced compared to the variation of the first spectrum data according to other parameters or other process conditions. Thus, the accuracy of principal component analysis or principal component extraction may be improved.

In an example embodiment, the apparatus 10 may determine the number of one or more principal components (the principal components 710, 720 and 730) based on the variation of the first spectrum data with respect to wavelength in order for the variance by the principal components 710, 720 and 730 to be greater than the preset value. For example, when the preset value is 90%, if the variance of the first spectrum data by the two principal components (the principal components 710 and 720) is more than 90%, the apparatus 10 may determine the number of principal components (the principal components 710, 720 and 730) to be 2 and may extract only 2 principal components (the principal components 710 and 720). FIG. 7 illustrates that three principal components 710, 720 and 730 are extracted. However, the number of the principal components are not limited thereto.

FIG. 8 is a drawing for explaining a method of calculating a principal component distance according to an example embodiment.

FIG. 8 illustrates an area where each axis represents one or more principal components of the first spectrum data, described with reference to FIG. 7. FIG. 8 illustrates a 3D space with three principal components as axes (PCA-1, PCA-2 and PCA-3), but the space for calculating the principal component distance may be determined according to the number of extracted principal components.

In an example embodiment, the apparatus 10 may calculate principal component distances corresponding to each of a plurality of measurement points based on one or more principal components. The principal component distance is a parameter that indicates how far apart the values of the first spectrum data corresponding to each of multiple measurement points are in the principal component space. For example, the principal component distance may be calculated as the distance from the origin of the principal component space. In another example embodiment, the principal component distance may also be computed as the distance from the mean point on the principal component axis. However, the point that serves as the reference for the principal component distance is not limited thereto.

FIG. 8 illustrates the example embodiment in which the apparatus 10 calculates the principal component distance using the Euclidean distance. However, the principal component distance may be computed using not only the Euclidean distance but also the cosine distance, triangle similarity, and sector's area similarity.

As described with reference to FIG. 6, since the first grid map is generated for each reference substrate and one or more test substrates, the principal component distances for generating the first grid map may also be calculated for each of a reference substrate (reference substrate of FIG. 8), and one or more test substrates (a test substrate 1 and a test substrate 2 of FIG. 8) as illustrated in FIG. 8.

Hereinafter, the apparatus 10 may generate a first grid map by mapping the gradient of the generated principal component distances to a grid map for a semiconductor substrate.

Referring to FIG. 2, in operation 230, the apparatus 10 may train the prediction model based on the first grid map and the second grid map.

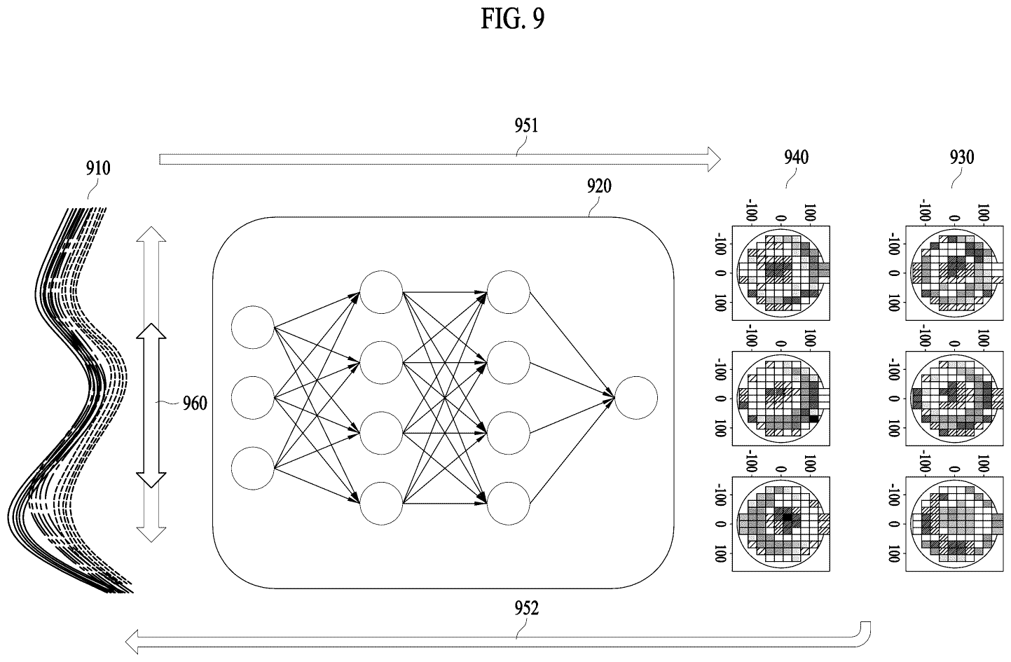

FIG. 9 is a diagram illustrating a method of training a prediction model according to an example embodiment.

FIG. 9 illustrates first spectrum data 910, and a first grid map 930 and a second grid map 940 which are generated based on the first spectrum data 910.

As described above, the second grid map 940 may be generated from the first spectrum data 910 using a prediction model 920. The prediction model 920 may receive the first spectrum data 910 as input and generate prediction values corresponding to each of multiple measurement points through forward propagation 951, and the apparatus 10 may generate the second grid map 940 based on the prediction value. Forward propagation refers to the process in which the input data, the first spectrum data 910, is transformed as it passes through each layer of the neural network of the prediction model.

In an example embodiment, the apparatus 10 may compute the first association index between the first grid map 930 and the second grid map 940. In an example embodiment, the apparatus 10 may normalize the first grid map 930 and the second grid map 940. Each of the first grid map 930 and the second grid map 940 reflects the gradient of a specific pattern, which is the result of dimension reduction, and the gradient of the prediction value of the parameter of interest, and the scale of the value may differ. Therefore, the apparatus 10 may normalize the size of the values of each square of the grid (or coordinate) in the first grid map 930 and the second grid map 940 to a predetermined range (for example, −3 to 3). In an embodiment, the normalization may refer to scaling the values in the first grid map 930 and the second grid map 940 so that the values fall within a specific range such as −3 to 3.

In an example embodiment, the first association index may be the coefficient of determination between the normalized first grid map 930 and the normalized second grid map 940. The coefficient of determination between the first grid map 930 and the second grid map 940 is an indicator of the correlation between the first grid map 930 and the second grid map 940, and the coefficient of determination implies how well the first grid map 930 describes the second grid map 940. The coefficient of determination has a value between 0 and 1, and the closer the value is to 1, the higher the correlation between the first grid map 930 and the second grid map 940.

In an example embodiment, the apparatus 10 may determine the loss function of the prediction model 920 based on the first association index, and train the prediction model 920 through back propagation 952 algorithm based on the loss function. The prediction model 920 is trained in the direction of minimizing the loss function, and thus the apparatus 10 may train the prediction model 920 in the direction that minimizes the difference between the first grid map 930 and the second grid map 940.

In an example embodiment, the apparatus 10 may compute a second association index between the experimental value for the parameter of interest and the predicted value corresponding to the experimental value. As described above, experimental values are obtained only from destructive testing points among multiple measurement points, and thus the prediction value corresponding to the experimental value may indicate the prediction value of the parameter of interest output by the prediction model for the destructive testing point. The second association index between the experimental value and the predicted value may be the coefficient of determination between the experimental value and the predicted value. The closer the coefficient of determination is to 1, the higher the correlation between the experimental value and the predicted value.

In an example embodiment, the apparatus 10 may determine the loss function of the prediction model 920 based on the second association index, and train the prediction model 920 through the back propagation 952 algorithm based on the loss function. For example, the apparatus 10 may train the prediction model 920 in a direction that minimizes the difference between experimental values and predicted values corresponding to experimental values.

In an example embodiment, the apparatus 10 may determine the loss function based on the difference between the first association index and the second association index. In an example embodiment, the loss function may be the root mean square error between the first association index and the second association index, but is not limited thereto. Accordingly, the apparatus 10 may train the prediction model 920 in the direction of minimizing the difference between the first association index and the second association index.

In an example embodiment, a sampling operation 960 may be performed to get the wavelength range of the first spectrum data 910 by the apparatus for minimizing the loss function. For example, when the wavelength range of the first spectrum data 910 used for training the initial prediction model 920 is 200 nm to 1700 nm, according to the example embodiment described above, the sampling operation 960 may be performed to determine the wavelength range (for example, 800 nm to 900 nm) for minimizing the loss function. For example, the apparatus 10 may scan the wavelength range of the first spectrum data 910 based on the sampling interval (for example, 10 nm) by repeatedly training the prediction model 920, and thus select a wavelength range where the loss function is minimized. In another example embodiment, the apparatus 10 may also perform binary selection sampling to select or remove specific features of the first spectrum data 910. In this case, it may be expressed as whether a specific wavelength range is selected (1) or not selected (0). This is to select a wavelength that responds sensitively to the parameter of interest of the target structure, and by which the performance of the prediction model may be further improved.

The apparatus 10 may generate the final prediction model by training the above described example embodiments and the prediction model 920 and by performing the sampling operation 960 to get the optimal wavelength range of the first spectrum data 910.

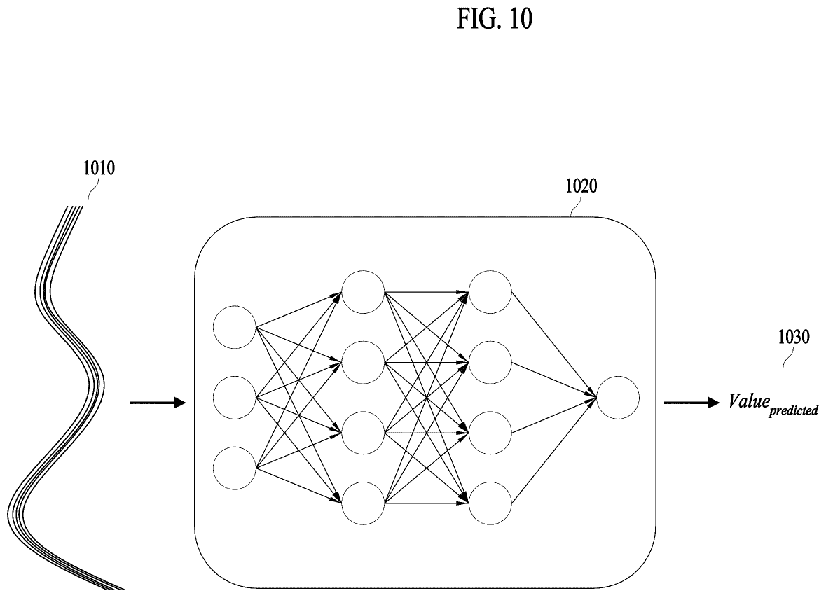

FIG. 10 is a diagram illustrating a method of obtaining a final prediction value according to an example embodiment.

In an example embodiment, based on the loss function or coefficient of determination being smaller than the preset threshold value, the apparatus may determine a prediction model 1020 trained up to that point as the final prediction model.

In an example embodiment, by using the trained prediction model 1020, the apparatus may obtain a final prediction value 1030 of the parameter of interest from spectrum data 1010 (i.e., an input spectrum data) for the target structure. For example, the spectrum data 1010 may be obtained from the target structure. Accordingly, the spectrum data is acquired non-destructively from arbitrary semiconductor substrates, and by inputting the spectrum data into the trained prediction model 1020, the final prediction value 1030 for the parameter of interest of the target structure to be measured on the semiconductor substrate may be obtained.

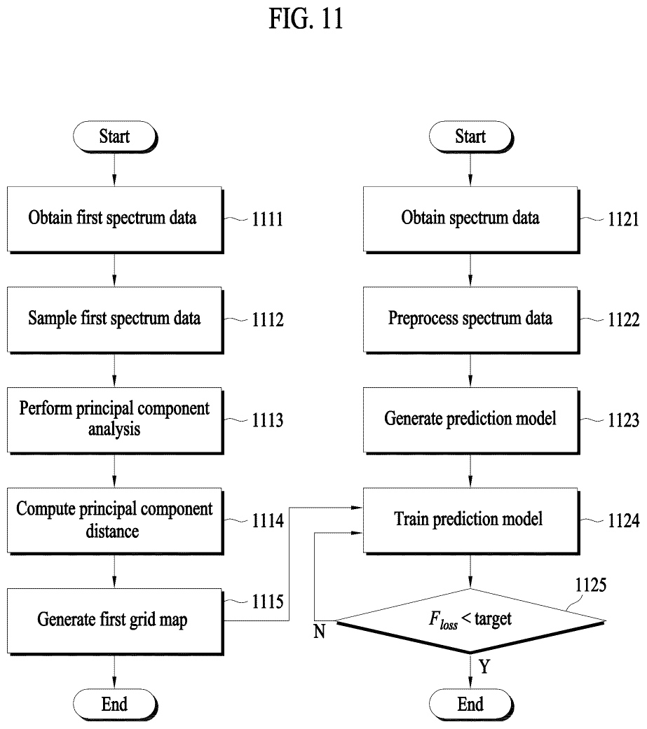

FIG. 11 is flowcharts of a method of generating a prediction model according to an example embodiment.

FIG. 11 illustrates the process of the apparatus 10 generating the first grid map (operation 1111 to operation 1115) and the process of the apparatus 10 generating a prediction model using the first grid map (operation 1121 to operation 1125).

In operation 1111, the apparatus 10 may obtain first spectrum data for a target structure of a semiconductor substrate. For example, the first spectrum data may be obtained from the target structure. The first spectrum data may indicate spectrum data for multiple measurement points of the semiconductor substrate.

In operation 1112, the apparatus 10 may sample the first spectrum data.

In an example embodiment, the apparatus 10 may remove outliers from the first spectrum data. For example, the apparatus 10 may remove outliers from the first spectrum data using visualization, statistical methods, and machine learning methods. The apparatus 10 may visualize the first spectrum data using libraries (for example, matplotlib or seaborn), and remove outliers with extremely different values. Alternatively, the apparatus 10 may remove spectrum data that fall outside a preset standard deviation range from the mean of the first spectrum data by considering the spectrum data as outliers. The apparatus 10 may remove the outliers from the first spectrum data by using machine learning such as isolation forest and one-class SVM. However, the method by which the apparatus 10 removes outliers from the first spectrum data is not limited thereto.

In an example embodiment, the apparatus 10 may sample the first spectrum data with outliers removed. For example, among several wavelength ranges of the first spectrum data the apparatus 10 may select a specific wavelength range to perform principal component analysis. A specific wavelength range may represent a wavelength range that is known to be meaningful in principal component analysis. The apparatus 10 may set the sampling interval. For example, the apparatus 10 may sample data at regular intervals at all wavelengths, narrow the sampling interval to extract more samples at a particular wavelength, and extend the sampling interval at different wavelengths.

In operation 1113, the apparatus 10 may perform principal component analysis on the first spectrum data. The apparatus 10 may perform the principal component analysis on the first spectrum data to extract one or more principal components.

In operation 1114, the apparatus 10 may compute a principal component distance based on one or more extracted principal components. For example, in a space with each of one or more principal components as an axis, the apparatus 10 may calculate the principal component distance corresponding to each of the measurement points.

In operation 1115, the apparatus 10 may generate a first grid map based on the calculated principal component distances. In an example embodiment, the apparatus 10 may generate a first grid map by mapping the gradient of the principal component distance corresponding to each of the multiple measurement points to a grid map for the semiconductor substrate. In another example embodiment, the apparatus 10 may also generate a first grid map by mapping the gradient of the principal component distance corresponding to a square of the grid containing two or more points among the multiple measurement points to a grid map for the semiconductor substrate. The square of the grid containing two or more points among the multiple measurement points may indicate each square of the grid of the first grid map corresponding to multiple measurement points in a many-to-one manner when generating a low-resolution grid map as described above. The first grid map generated through operation 1111 to operation 1115 may be used for training the prediction model in operation 1124.

In operation 1121, the apparatus 10 may obtain spectrum data. The spectrum data may include first spectrum data and second spectrum data. For example, the apparatus 10 may obtain second spectrum data on a target structure of a semiconductor substrate. Unlike the first spectrum data, which indicates spectrum data for multiple measurement points of the semiconductor substrate, the second spectrum data is spectrum data for at least one of multiple measurement points of the semiconductor substrate. For example, the second spectrum data may be identical to the first spectrum data, or may contain only a portion of the first spectrum data.

In operation 1122, the apparatus 10 may preprocess the spectrum data. For example, the apparatus 10 may perform outlier removal, sampling interval setting, and wavelength range selection for the spectrum data, similar to operation 1112.

In operation 1123, the apparatus 10 may generate a prediction model. For example, the apparatus 10 may set the initial parameters of the prediction model.

In operation 1124, the apparatus 10 may train a prediction model. As described above, in an example embodiment, the apparatus 10 may train a prediction model to minimize a loss function, and the loss function may be determined based on a first association index between the first grid map and the second grid map, a second association index between an experimental value and a predicted value corresponding to the experimental value, and difference between the first association index and the second association index. The apparatus 10 may also sample the wavelength range of the first spectrum data so that the loss function is minimized.

In operation 1125, the apparatus 10 may determine whether the loss function (Fₗₒₛₛ) is less than a preset threshold value (target). When the loss function is greater than the preset threshold value, the apparatus 10 repeats the training according to operation 1124 via the back propagation algorithm, and when the loss function is below the preset threshold value, the apparatus 10 may determine the trained prediction model as the final prediction model.

FIG. 12 is a block diagram of a prediction system according to an example embodiment.

Referring to FIG. 12, a prediction system 1 may include the inspection apparatus 20 and a prediction apparatus 30.

In an example embodiment, the inspection apparatus 20 may irradiate the incident polarization on the semiconductor substrate, the inspection apparatus 20 may obtain at least one of the transmission polarization and the reflection polarization of the incident polarization for the semiconductor substrate, and output spectrum data for a target structure of a semiconductor substrate based on at least one polarization. The inspection apparatus 20 may generate first spectrum data for multiple measurement points on a semiconductor substrate. The generated first spectrum data may be stored in a memory inside the inspection apparatus 20, or stored in a separate memory or server outside the inspection apparatus 20.

In an example embodiment, the prediction apparatus 30 may output prediction values for parameters of interest of the target structure based on spectrum data using a prediction model. As described above, the prediction model may be trained based on the first grid map generated by reducing the dimension of the first spectrum data and the second grid map generated from first spectrum data using a prediction model.

The prediction apparatus 30 may be a physical apparatus internal or external to the apparatus 10 that generates the prediction model described through FIG. 1 to FIG. 11. In this case, the prediction apparatus 30 may be equipped with a communication part configured to communicate with the apparatus 10. Alternatively, the prediction apparatus 30 and the apparatus 20 may be a program or set of instructions stored in the memory of one electronic apparatus. The prediction apparatus 30 may be a physical or logical part of the apparatus 20, and may be a device that exists outside of the apparatus 10.

Below, the inspection apparatus 20 is described in detail.

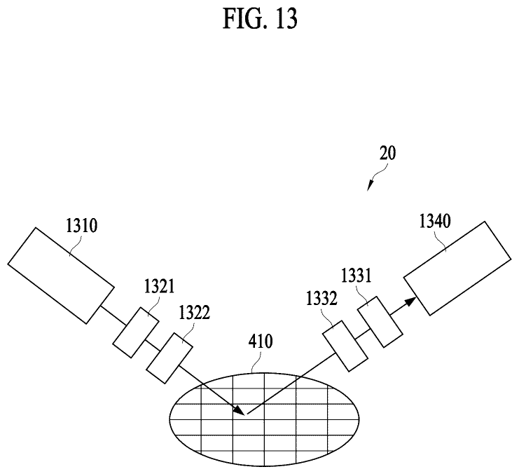

FIG. 13 is a drawing illustrating an inspection apparatus according to an example embodiment.

In an example embodiment, the inspection apparatus 20 may obtain first spectrum data and second spectrum data based on non-destructive inspection of the semiconductor substrate 410. Light is a type of wave, and light that has one type of wavelength or one direction is called polarized light. When light of known polarization degree is irradiated onto a target structure of the semiconductor substrate 410 to be inspected, the polarization state changes by reflection or transmission on the semiconductor substrate 410, and by measuring this changed polarization, the characteristics of the target structure (in particular, the parameter of interest) are detected. The detection is possible through difference between longitudinal wave (p polarization) and transverse wave (s polarization), Reflection Amplitude Ratio Angle, complex reflectance ratio, and relationship between amplitudes of the longitudinal wave and the transverse wave. The first spectrum data and the second spectrum data contain this information.

Conversely, the experimental values described above may be obtained based on destructive inspection of the semiconductor substrate 410. Experimental values may be obtained through destructive testing methods such as TEM, SEM, and SPAS on the semiconductor substrate 410.

Referring to FIG. 13, the inspection apparatus 20 may include a light source 1310, a polarizer 1321, compensators 1322 and 1332, the semiconductor substrate 410, an analyzer 1331, and a detector 1340.

The light source 1310 irradiates light to at least some of the multiple measurement points on a semiconductor substrate, and the irradiated light passes through the polarizer 1321 and becomes polarized. The polarized light is reflected from or transmitted through the semiconductor substrate 410. The polarization state of this reflected or transmitted light is measured in the analyzer 1331, and changes in polarization state may be detected. After then, the detector 1340 may collect data by measuring the intensity of light passing through the analyzer 1331.

The compensator 1322 may be located between the light source 1310 and the polarizer 1321 or between the polarizer 1321 and the semiconductor substrate 410. The compensator 1322 may introduce or remove a specific phase difference between two orthogonal polarization components of polarization, and thus the change in polarization of light reflected or transmitted from the semiconductor substrate 410 may be measured more precisely.

FIG. 13 illustrates that the inspection apparatus 20 is an ellipsometer. However, in an example embodiment, the inspection apparatus 20 is not limited to the ellipsometer, and the inspection apparatus 20 may be, for example, reflectometry. For example, the inspection apparatus 20 may be a reflectometry having normal incidence and normal reflection types. The light source 1310 of the inspection apparatus 20 is configured to irradiate light to at least some of the multiple measurement points of the semiconductor substrate 410, the irradiated light is reflected from the semiconductor substrate 410, and the polarization state of this reflected light may be collected as spectrum data via the detector 1340. The inspection apparatus 20 may include a beam splitter (not illustrated), the beam splitter (not illustrated) may split light so that light emitted from the light source 1310 is incident perpendicularly on the semiconductor substrate 410 and direct the reflected light from the semiconductor substrate 410 to the detector 1340.

FIG. 13 illustrates the compensator 1322, but the compensator 1322 may not be included in the inspection apparatus 20.

In an example embodiment, the inspection apparatus 20 may further include a post-processing apparatus (not illustrated). The post-processing apparatus (not illustrated) may generate first spectrum data and second spectrum data based on the data collected by the detector 1340.

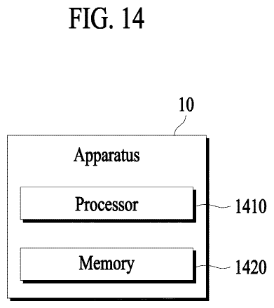

FIG. 14 is a block diagram of an apparatus for generating a prediction model according to an example embodiment.

Referring to FIG. 14, the apparatus 10 may include a processor 1410 and a memory 1420. With respect to the apparatus 10, FIG. 14 illustrates only the components relevant to example embodiments. Therefore, it will be understood by those skilled in the art that other general components may be included in addition to the components illustrated in FIG. 14.

As a hardware that stores various data processed within the apparatus 10, the memory 1420 may store programs for processing and controlling the processor 1410.

The memory 1420 may include random access memory (RAM), such as dynamic random access memory (DRAM), static random access memory (SRAM), read-only memory (ROM), electrically erasable programmable read-only memory (EEPROM), CD-ROM, Blu-ray or other optical disk storage, hard disk drive (HDD), solid state drive (SSD) or flash memory.

The processor 1410 controls the overall operation of the apparatus 10. For example, the processor 1410 may control an input receiving part (not illustrated), a display (not illustrated), a communication part (not illustrated), or the memory 1420 by executing programs stored in the memory 1420. The processor 1410 may control the operation of the apparatus 10 by executing programs stored in the memory 1420.

The processor 1410 may control at least some of the operations of the apparatus described in FIG. 1 to FIG. 13.

The processor 1410 may be implemented using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and electrical units for performing other functions.

In an example embodiment, the apparatus 10 may be a server. The server may be implemented as a computer apparatus or multiple computer apparatuses that communicate over a network to provide commands, codes, files, content, services and so on. The server may receive the data needed to generate a prediction model, and generate a prediction model based on the data received.

The apparatus 10 may further include a communication section (not illustrated). The communication part (not illustrated) may include one or more components that enable wired/wireless communication with an external server or external apparatus. For example, communication part (not illustrated) may include at least one of a short-range communication part (not illustrated), a mobile communication part (not illustrated) and a broadcast receiving part (not illustrated). In an example embodiment, the communication part (not illustrated) may receive data for generating a prediction model.

The electronic device according to the above-described example embodiments may include a processor, a memory for storing and executing program data, a permanent storage such as a disk drive, and/or a user interface device such as a communication port, a touch panel, a key and/or a button that communicates with an external device. Methods implemented as software modules or algorithms may be stored in a computer-readable recording medium as computer-readable codes or program instructions executable on the processor. The computer-readable recording medium includes a magnetic storage medium (for example, ROMs, RAMs, floppy disks and hard disks) and an optically readable medium (for example, CD-ROMs and DVDs). The computer-readable recording medium may be distributed among network-connected computer systems, so that the computer-readable codes may be stored and executed in a distributed manner. The medium may be readable by a computer, stored in a memory, and executed on a processer.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic and/or look-up table, that may execute various functions by the control of one or more microprocessors or other control devices. Similar to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

The above-described example embodiments are merely examples, and other embodiments may be implemented within the scope of the claims to be described later.

What is claimed is:

1. A method of generating a trained prediction model, the method comprising:
obtaining first spectrum data from a target structure of a semiconductor substrate;
generating a first grid map for the semiconductor substrate by reducing dimension of the first spectrum data;
generating a second grid map for the semiconductor substrate from the first spectrum data by using a prediction model for a parameter of interest of the target structure; and
training the prediction model based on the first grid map and the second grid map.

2. The method of claim 1, further comprising:
generating the prediction model based on second spectrum data and an experimental value of the parameter of interest corresponding to the second spectrum data,
wherein the second spectrum data are obtained from the target structure corresponding to at least one among a plurality of measurement points of the semiconductor substrate.

3. The method of claim 2,
wherein generating the second grid map comprises:
obtaining a prediction value of the parameter of interest corresponding to the first spectrum data using the prediction model; and
generating the second grid map based on the prediction value corresponding to each of the plurality of measurement points.

4. The method of claim 3,
wherein generating the second grid map based on the prediction value comprises:
generating the second grid map where a gradient of the prediction value is mapped to a grid map for the semiconductor substrate, and
wherein the grid map represents location information of the plurality of measurement points.

5. The method of claim 1,
wherein generating the first grid map comprises:
extracting one or more principal components from the first spectrum data by performing principal component analysis on the first spectrum data;
calculating principal component distance corresponding to each of a plurality of measurement points of the semiconductor substrate based on the one or more principal components; and
generating the first grid map based on the principal component distance.

6. The method of claim 5,
wherein the generating of the first grid map based on the principal component distance comprises:
generating the first grid map where a gradient of the principal component distance is mapped to a grid map for the semiconductor substrate, and
wherein the grid map represents location information of the plurality of measurement points.

7. The method of claim 5,
wherein the extracting of the one or more principal components comprises:
based on an amount of change in the first spectrum data for a wavelength, determining a number of the one or more principal components,
wherein the one or more principal components represent variance of the first spectrum data which has a preset value or greater.

8. The method of claim 1,
wherein the first spectrum data, the first grid map and the second grid map are generated corresponding to each of a reference substrate and one or more test substrates to which with at least one process condition of the reference substrate is changed and applied.

9. The method of claim 3,
wherein the training of the prediction model comprises:
calculating a first association index between the first grid map and the second grid map;
determining a loss function of the prediction model based on the first association index; and
training the prediction model through a back propagation algorithm based on the loss function.

10. The method of claim 9,
wherein the calculating of the first association index comprises:
normalizing the first grid map and the second grid map, and
wherein the first association index is a coefficient of determination between the normalized first grid map and the normalized second grid map.

11. The method of claim 9,
wherein the determining of the loss function of the prediction model comprises:
calculating a second association index between the experimental value and the prediction value corresponding to the experimental value; and
determining the loss function based on difference between the first association index and the second association index.

12. The method of claim 11,
wherein the determining of the loss function of the prediction model further comprises:
determining a root mean square error between the first association index and the second association index as the loss function.

13. The method of claim 11,
wherein the training of the prediction model through the back propagation algorithm comprises sampling a wavelength range of the first spectrum data such that the loss function is minimized.

14. The method of claim 1, further comprises:
obtaining a final prediction value of the parameter of interest from an input spectrum data obtained from the target structure by using the trained prediction model.

15. The method of claim 2,
wherein the experimental value is obtained based on destructive inspection of the semiconductor substrate, and
wherein the first spectrum data and the second spectrum data are obtained based on non-destructive inspection of the semiconductor substrate.

16. The method of claim 1,
wherein a value corresponding to each cell of the first grid map and the second grid map is represented using a one-dimensional vector or a two-dimensional matrix.

17. The method of claim 16,
wherein an area of each square of the first grid map and the second grid map is expressed in color based on the value corresponding to each cell of the first grid map and the second grid map.

18. A prediction system comprising:
an inspection apparatus configured to:
irradiate incident polarized light onto a semiconductor substrate,
obtain at least one polarization of transmission polarization and reflection polarization of the incident polarized light reflected from the semiconductor substrate, and
output spectrum data for a target structure of the semiconductor substrate based on the at least one polarization; and
a prediction apparatus configured to output a prediction value for a parameter of interest of the target structure based on the spectrum data using a prediction model,
wherein the prediction model is trained based on a first grid map that is generated by reducing dimension of first spectrum data and a second grid map that is generated from the first spectrum data using the prediction model, and
wherein the first spectrum data is obtained from a plurality of measurement points of the semiconductor substrate using the inspection apparatus.

19. An apparatus of generating a trained prediction model, the apparatus comprising:
a memory configured to store at least one program; and
at least one processor configured to execute the at least one program,
wherein the at least one processor is configured to:
obtain first spectrum data for a target structure of a semiconductor substrate;
generate a first grid map for the semiconductor substrate by reducing dimension of the first spectrum data;
generate a second grid map for the semiconductor substrate from the first spectrum data by using a prediction model for a parameter of interest of the target structure; and
train the prediction model based on the first grid map and the second grid map.

20. A non-transitory computer-readable recording medium having a program for executing the method of claim 1 on a computer.
